(19) United States
(12) Patent Application Publication
(10) Pub. No.: US 2013/0076909 A1
(43) Pub. Date: Mar. 28, 2013

(54) SYSTEM AND METHOD FOR EDITING ELECTRONIC CONTENT USING A HANDHELD DEVICE

(71) Applicants: Stefan J. Marti, Santa Clara, CA (US); Seung Wook Kim, Cupertino, CA (US); Eric Liu, Santa Clara, CA (US); Alison Wong, Menlo Park, CA (US)

(72) Inventors: Stefan J. Marti, Santa Clara, CA (US); Seung Wook Kim, Cupertino, CA (US); Eric Liu, Santa Clara, CA (US); Alison Wong, Menlo Park, CA (US)

(21) Appl. No.: 13/246,254

(22) Filed: Sep. 27, 2011

(51) Int. Cl. H04N 5/225; H04N 5/33

(52) U.S. Cl. 348/164; 348/207.1; 348/E05.024; 348/E05.09

(57) ABSTRACT

Embodiments of the present invention disclose a system and method for editing electronic content using a handheld device. According to one example embodiment, the system includes a mobile computing device hosting electronic content, and a handheld imaging device. The handheld imaging device is configured to communicate with the mobile computing device and includes an optical sensor for capturing image data associated with an object or area. Still further, the handheld imaging device is configured to transmit and designate a location for insertion of said image data into the electronic content hosted on the mobile device.

### BACKGROUND

The emergence and popularity of mobile computing has made portable electronic devices, due to theft compact design and light weight, a staple in today's marketplace. Mobile devices such as smartphones and tablet personal computers involve advanced computing functionality and are capable of multi-tasking using various applications. For example, users operating such devices are able to send and receive emails while browsing the internet, or capture images while viewing electronic documents. However, complex document editing on these mobile computing platforms is generally a laborious and time-intensive process for operating users.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a high level block diagram of a system for editing electronic content on a mobile computing device using a handheld imaging device according to an example of the present invention.

FIGS. 2A and 2B are simplified sectional views of the handheld imaging device and an object insertion method thereof according to an embodiment of the present invention.

FIGS. 3A-3D are illustrations for electronic content editing on a mobile computing platform using a handheld imaging device according to an example of the present invention.

FIGS. 4A-4C are illustrations for the processing steps for background removal after structured light data processing using a handheld imaging device according to an example of the present invention.

FIGS. 5A-5F are illustrations of an operating environment for electronic content editing on a mobile computing platform using a handheld imaging device according to an example embodiment of the present invention.

FIG. 6 is a simplified flow chart of the processing steps for editing electronic content on a mobile computing platform using a handheld imaging device according to an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

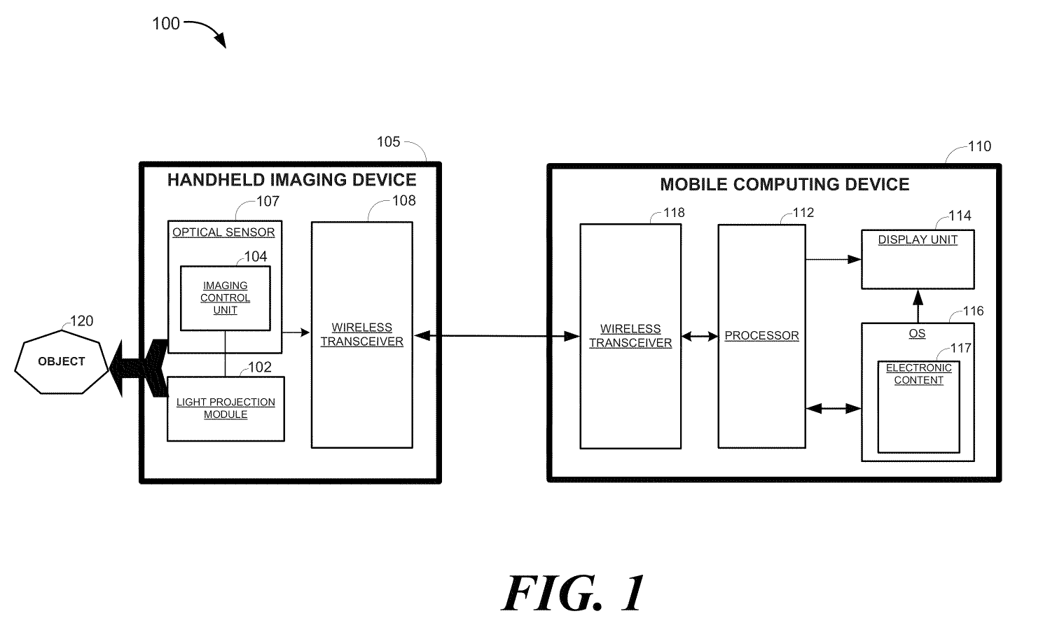

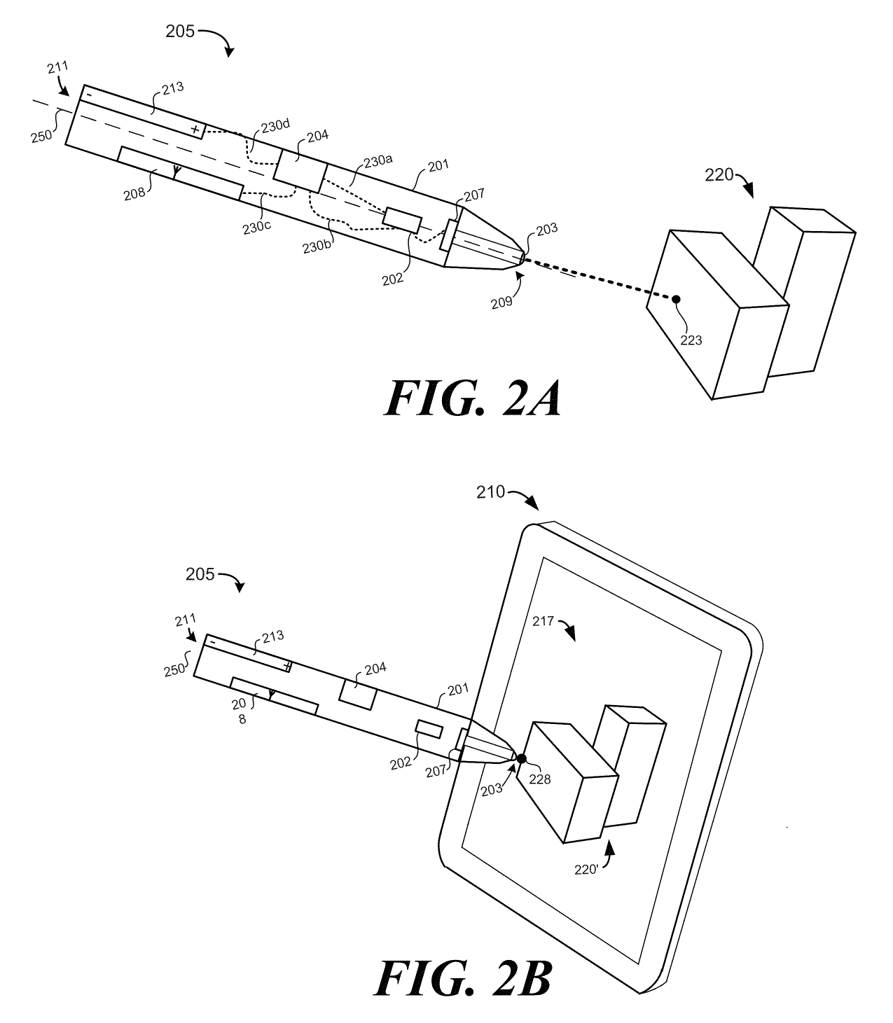

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

When editing electronic documents on a handheld display device, it is often cumbersome to instantaneously insert an image or video of a real world object nearby into such a document in real-time. Prior solutions for document editing includes the use of a back facing camera—built into the handheld display device—to capture a picture or video and then insert the captured image or video data into the electronic document. Another solution includes taking a picture or video with a digital camera device and then transferring this image onto the handheld display device using wired or wireless connections, and finally importing the file into the electronic document. Still another prior solution focuses on transferring complex object properties from real world objects to a digital canvas. In such a configuration, the camera must be in close proximity to the objects in order to register the particular object properties for insertion onto the digital canvas. As such, there is a need in the art for capturing all data pertaining to an imaged object (e.g., white board content, paper document, three-dimensional object) and allowing for an efficient and user-friendly mechanism to insert said data into electronic content associated with a mobile computing device.

Examples of the present invention provide a system and method for editing electronic content using a handheld imaging/input device. According to one example, the mobile computing device hosts electronic content for editing by an operating user. The handheld imaging device is configured to communicate wirelessly with the mobile computing device and includes an optical sensor for capturing image data associated with a target object. Moreover, image data captured by the handheld imaging device is capable of being analyzed and processed so as extract image data pertaining to the target object. Based on a location designation from the operating user, said processed image data may then be inserted into the electronic content hosted on the mobile device.

Referring now in more detail to the drawings in which like numerals identify corresponding parts throughout the views, FIG. 1 is a high level block diagram of a system for editing electronic content on a mobile computing platform using a handheld imaging device according to an example of the present invention. As shown in this example, the system 100 includes a handheld imaging device 105 and a mobile computing device 110. The mobile computing device 110 includes a processor 112 coupled to a display unit 114, a mobile operating system 116, and a wireless transceiver 118. In one example embodiment, processor 112 represents a central processing unit (CPU), microcontroller, microprocessor, or logic configured to execute programming instructions associated with the mobile device 110. The display unit 114 of the mobile device represents an electronic visual display configured to display images and graphics for viewing by an operating user. The mobile operating system 116 is configured to execute and run software applications and host electronic content. As used herein, electronic content represents digital content or media such as word processing documents, online content, digital images, or any other form of electronic content capable of being stored on a storage medium and edited by an operating user. The mobile operating system may also include a graphical user interface for enabling input interaction between an operating user and the mobile device 110. In addition, mobile device 110 includes a wireless transceiver 118 for sending and receiving data to/from the handheld imaging device 105.

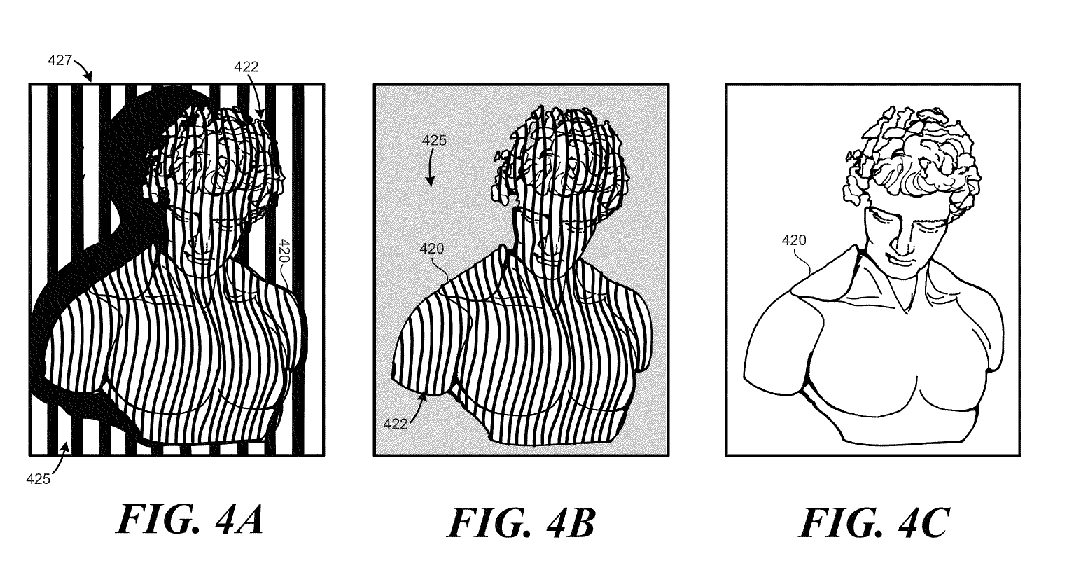

The handheld imaging and input device 105, which may resemble a pen stylus or wand for example, includes at least one optical sensor 107 (e.g., color sensor, depth sensor, etc.) for scanning or imaging objects, a light projection module 102, a imaging control unit 104, and a wireless transceiver 108 for communicating with the mobile computing device 110. Moreover, the optical sensor 107 may be configured to capture images and/or video associated with a target object. According to one example, light projection module 102 is configured to project an identifiable marking (e.g., laser dot, bounding box) around a target object 120 for easy view finding and framing during the scan process. Furthermore, the light projection module 102 may produce an infrared or visible structured pattern in order to register topography information of the target object and its surroundings, such as the angle between an object (e.g., paper document) and the input device 105. Such information may be used by the imaging control unit to normalize the captured image (e.g., de-skew a flat object such as a paper, or to distinguish an object from its background) as will be explained in further detail with reference to FIG. 4A-4C in which unwanted visual areas around the target object are removed by outlining the visually and topographically salient object. Furthermore, the imaging control unit 104 may utilize a number of sensor processing methods to crop superfluous data from the image based on the sensor data (e.g., color and topography) received from the optical sensor 107 and/or light projection module 102. Thus, the handheld imaging device 105 of the present examples if capable of processing, editing, transmitting, and displaying (remotely) data associated with an imaged object or area.

According to one example, the optical sensor 107 is an imaging sensor which can be used for capturing both still and moving images (i.e., photos and videos). Alternatively, a depth sensor can be incorporated into the present examples (e.g., based on time-of-flight technology, ultrasound, infrared, radar, etc.) so as provide depth information (e.g., per pixel, or as a 2.5D depth map). Other sensors may include single or multiple photo diodes with each diode capable of picking up different wave lengths for use as a color picker, imagers in the nonvisible light range, and the like. Moreover, the imaging control unit 104 may be included either within the handheld imaging device 105 or within the mobile computing device 110. The handheld imaging device 105 may be connected and in communication with the mobile computing device 110 wirelessly via Bluetooth, radio frequency (RF) or any other short-range wireless communication protocol. Alternatively, the handheld device 105 and mobile device 110 may include a wired connection (e.g., USB, firewire). In accordance with examples of the present invention, the imaged object 120 may be inserted in real-time into electronic content 117 hosted on the mobile computing device 110 (e.g., tablet personal computer, smartphone, etc.).

FIGS. 2A and 2B are simplified sectional views of the handheld imaging device and an object insertion method according to an embodiment of the present invention. As shown in these examples, the handheld imaging device 205 is represented as a pen-shaped device and includes a housing 201 and a tip portion 203. As shown here, the tip portion 203 is formed at the front end 209 of the input device 205 opposite the back end 211, and along or parallel to the horizontal axis 250 passing through the front end 209 and back end 211 when the elongated side of the device 205 is placed parallel to the normal surface. Furthermore, housing 201 is elongated from the front end 209 to the back end 211 and provides enclosure for internal electrical components including optical sensor 207, imaging control unit 204, transmitter 208, and power unit 213, while contacts or wires 220a-220d provide electrical connections between these components. According to one example, the optical sensor 207 is positioned at a front position 209 near the tip 203 of the input device 205, with the central axis of the sensor either aligned with the long axis 250 of the input device 205, or mounted at an angle with respect to the long axis 250 of the input device 205. Alternatively, the optical sensor 207 could be mounted at a back end 209 of the input device 205 such that imager faces in an outward direction, (e.g., perpendicular to the long axis of the pen).

In one embodiment, electrical contact 230a is utilized to connect the optical sensor 207 to the imaging control unit 204. Furthermore, and as shown in FIG. 2A, connection 230b enables electrical communication between light projection module 202 and imaging control unit 207. Still further, wire 220c connects the transmitter 208 to the imaging control unit 204. Transmitter 208 provides wireless transmission of the image data to the processor associated with the mobile computing device 210. Information may be communicated wirelessly by the transmitter 208 via radio frequency (RF) technology such as Bluetooth, or any other short-range wireless communication means. As discussed earlier, the wireless transmitter 208 may be omitted when the handheld imaging device 205 is directly connected to the mobile computing device 210 via a universal serial bus (USB) cable or any other wired interface means for establishing data communication between two devices. In the present example, power unit 213 provides power to the imaging control unit 204 via wire 220d and may be a rechargeable battery, or any other low voltage power supply. Additionally, the handheld imaging/input device 205 may include buttons and/or other input mechanisms for simulating additional functionality of a mouse or keyboard device

As shown in the example of FIG. 2A, and at the direction of the operating user, the light projection module 202 projects an identification marking 223 from the tip portion 203 of the handheld imaging device 205 onto a target object 220. Consequently, an image 220 associated with the target object 220 is captured by the optical sensor 207 and processed by the imaging control unit 204. Using the handheld imaging device 210, an operating user may then contact a surface of a mobile computing device 210 with the tip portion 203 of the handheld imaging device 210. Accordingly, image 220′ of the object 220 is then transferred (wirelessly or via a wired connection) to the mobile computing device 210 and inserted into the electronic content 217 at the surface contact position (i.e., designated location 228). Alternatively, the image 220′ of the object 220 may be transferred to a designated location 228 via a projection from the projection module (e.g., laser dot) rather than through physical contact of the handheld imaging device 205 onto a surface of the mobile device 210.

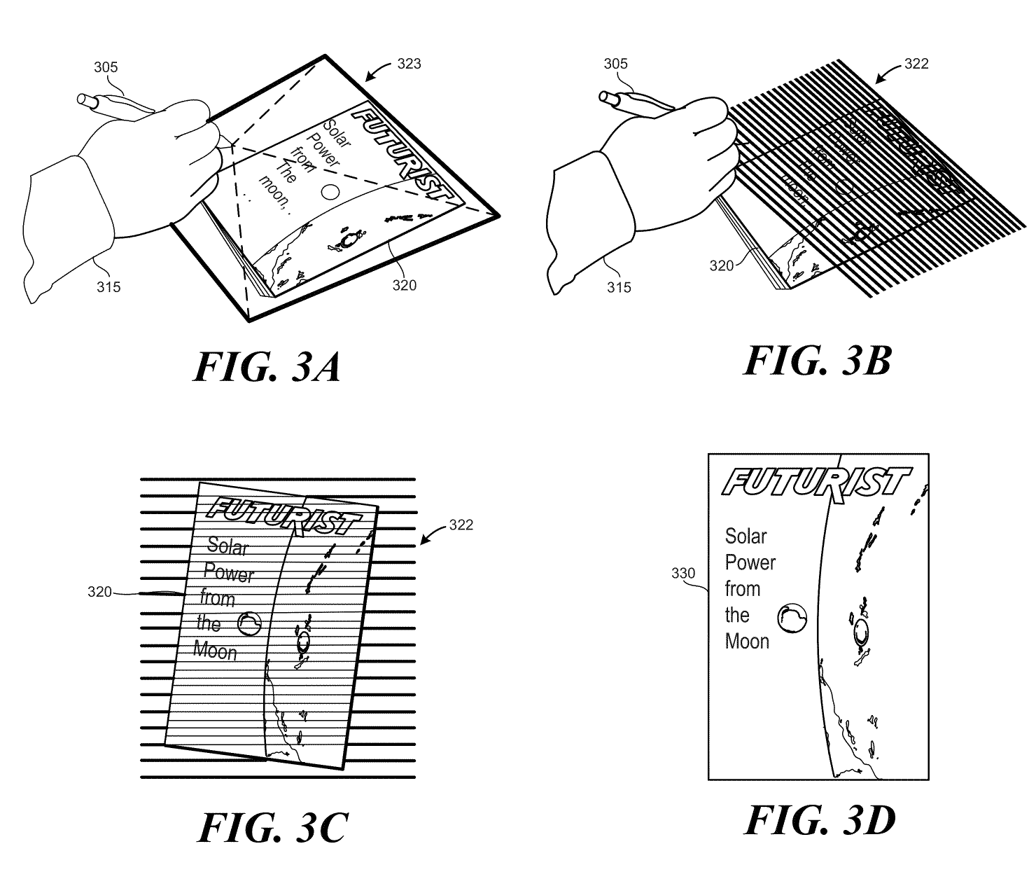

FIGS. 3A-3D are illustrations for electronic content editing on a mobile computing platform using a handheld imaging device according to an example of the present invention. According to one example embodiment, the light projection module of the handheld imaging device 305 projects a rectangular box (i.e., an identifiable marking 323) around the object 320 intended to be scanned so as to outline the field of view of the optical sensor of the handheld imaging device 305. Moreover, the identifiable marking 323 may be variable in size and shape via a slider or wheel on the handheld device so as to cause the bounding box to become smaller/larger for example. Still further, the bounding box 323 may be modified in size and shape using touch-related gestures (e.g., dragging a corner to make the bounding box smaller/larger/asymmetric). As shown in FIG. 3A, the identifiable marking or projection 323 is in line with the central axis of the handheld imaging device 305 and may be a laser-based projection. Alternatively, projection 323 could be based on miniature slide projection and/or similar methods. Furthermore, the light projection module (together with an imaging sensor) projects a structured grid 322 onto the scanned area 302 as shown in FIG. 3B. The structured grid 322 is utilized by the imaging control unit of the handheld imaging device 305 to analyze topography information of the scanned area 302. The topography information may include information about the overall angle of a flat object (such as paper document 320) with respect to the handheld imaging device 305. As shown in the top down view of FIG. 3C, topology information may be detected based on the structured line pattern on the object 320 in which thicker lines indicate objects of greater depth and further away from the projection module, while thinner and/or denser lines indicate closer objects. This data may then be used to normalize or de-skew the imaged object. To this end, the sensor processing module analyzes the sensor data (e.g., color, topography, etc.) in order to crop background data (e.g., greater depth) and extract the intended object data 330 as shown in FIG. 3D. In short, the configuration in accordance with examples of the present invention are able automatically remove unwanted visual areas around a imaged target object 320 by outlining the visually and topographically salient object and then eliminating superfluous data from the captured image.

FIGS. 4A-4C are illustrations for the processing steps for background removal after structured light data processing using a handheld imaging device according to an example of the present invention. Here, the desired object 420 for imaging is a male statue with a structured light pattern 422 being utilized to determine a depth map of the surrounding area associated with the object 420. As shown in FIG. 4A, the light projecting module (e.g., structured-light three-dimensional scanner) of the handheld device projects a light pattern of parallel stripes 422 over a targeted imaging area 427 including the statue 420 and a background region 425. According to one example embodiment, the sensor processing control unit analyzes the imaged information including the color and topography for example so as to determine depth information associated with the imaged area 427. More particularly, when projected onto the three-dimensional object surface, the displacement or geometrical deformation of the projected stripe pattern 422 reveals details about the object's 420 surface and background. For instance and as shown in FIG. 4A, the thick parallel lines of the structured light pattern 422 may serve to indicate objects of greater depth and thus background information, while the thinner parallel lines shown on the statue may serve as indications of closer foreground objects. Accordingly, the imaging control unit may remove data associated with wider parallel lines (background information) while maintaining the data associated with the thin parallel lines as shown in FIG. 4B. Lastly, FIG. 4C represents the desired image of the target object 420 for either transmission from the handheld imaging unit to the mobile computing unit, or for insertion into electronic media if image processing and analysis is performed locally on the mobile computing device. However, this is but one example of depth detection using a structured light scanning technique and any similar scanning or imaging method may be employed as will be appreciated by one skilled in the art.

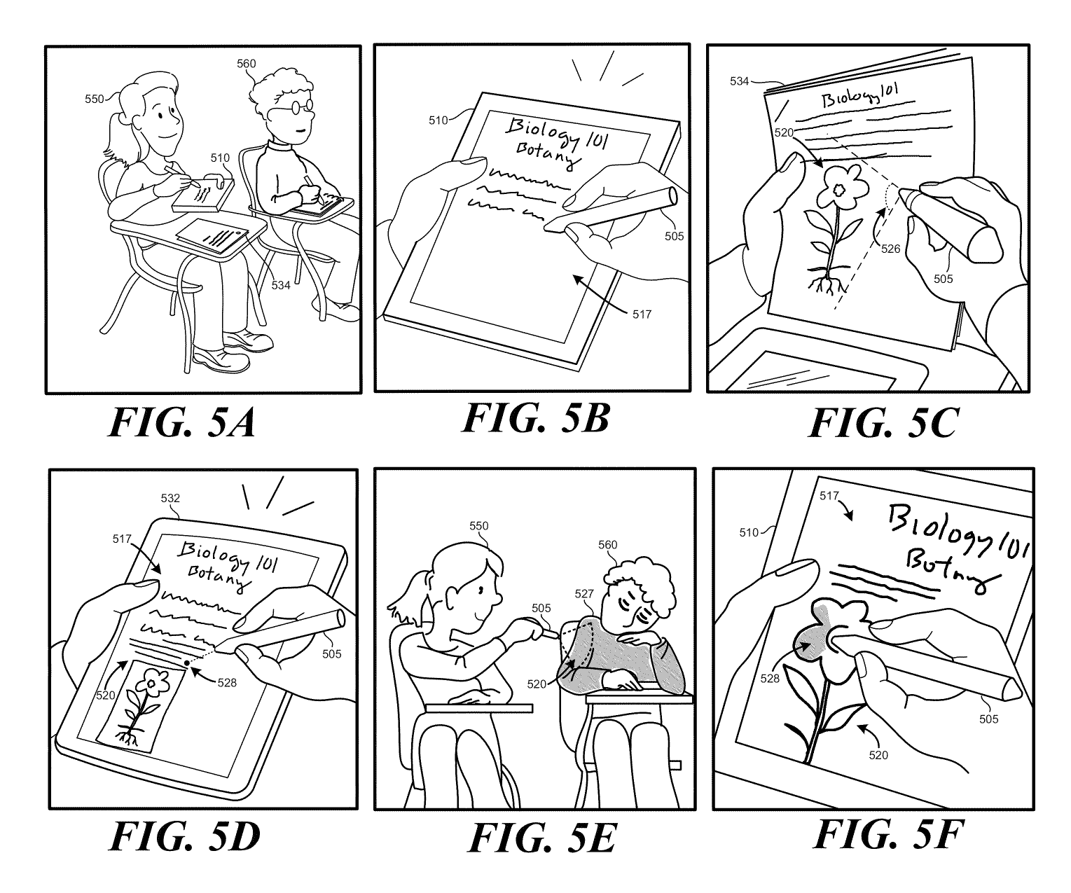

FIGS. 5A-5F are illustrations of an operating environment for electronic content editing on a mobile computing system using a handheld imaging device according to an example embodiment of the present invention. The operating environment of the present examples includes a classroom setting in which a user 550 operates a mobile computing device 532 hosting electronic media content, and a second student 560 sitting next to the operating user 550. Here, both students 550 and 560 also have paper handouts 534 distributed from the professor. As shown in FIG. 5B, the operating user 550 takes handwritten notes using the handheld imaging device 505 by editing electronic media content 517 hosted on the mobile computing device 510. Furthermore, the operating user 550 may utilize the handheld imaging and input device 505 to scan or image objects 520 from the paper handout 534 as shown in FIG. 5C. Here, the captured objects include a flower and text from the paper handout 534 as these objects lie within the field of view 526 of the handheld device's optical sensor. The imaged object 520 may then be inserted into the electronic content 517 of the mobile system 510 using the handheld imaging device 505. As shown in FIG. 5D, the captured image of the flower and text are inserted into a lower area of the electronic media content 517 based on a location designation 528 (e.g., touch or projection) from the operating user using the handheld imaging device 505.

In another use case scenario depicted in FIG. 5E, the operating user 550 may use the handheld imaging device 505 as a real world color picker for use in editing electronic content 517 on a mobile device. As shown in the present example, the handheld imaging device 505 is used to scan a target area 520 of a garment 527 worn by the nearby user 560. Thereafter, the operating user may elect to insert the color associated with the captured area 520 into the electronic media content 517 running on the mobile computing device 510. As depicted in FIG. 5F, the captured color is used to color a designated area 528 of the flower from the previously imaged object 520. That is, the previously captured color may be transferred on the electronic content via a series of pen-like strokes on the surface of the mobile computing device 510. In an alternate example, the previously captured color may be transferred onto the electronic content 517 via a press of a button on the handheld imaging device so as to indicate a location designation 528 on the display of the mobile computing device without physical contact between the two devices 505 and 510.

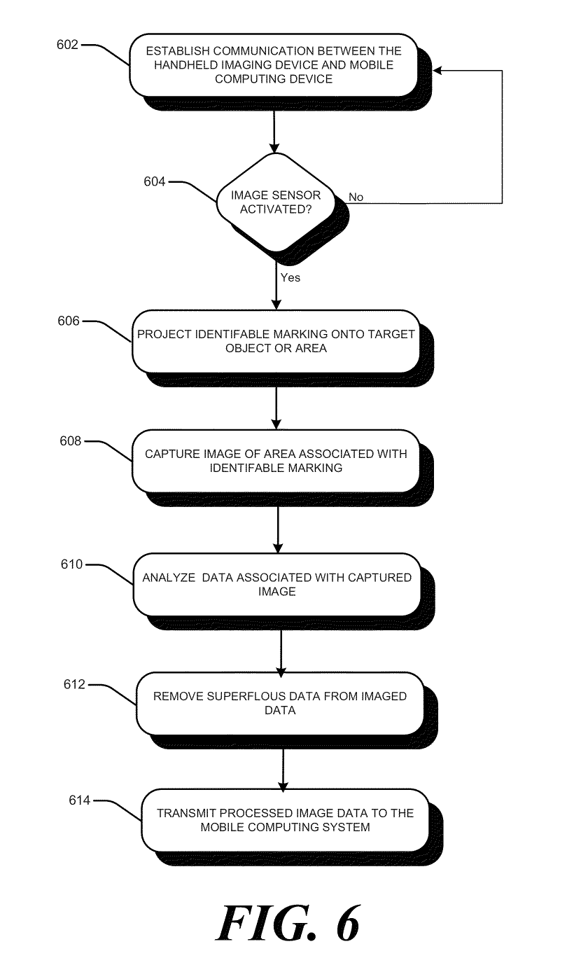

FIG. 6 is a simplified flow chart of the processing steps for editing electronic content on a mobile computing platform using a handheld imaging device according to an example of the present invention. In step 602, communication is established between the handheld imaging device and the mobile device. As mentioned above, the mobile computing device may be connected to the handheld imaging device wirelessly or via a wired connection. Next, in step 604, the imaging control unit of the device determines if the image sensor of the handheld imaging device has been activated (e.g., via a button), indicating the user's desire to capture an image associated with a target object or area. If so, then an identifiable marking is projected onto the target area or object in step 606. Next, in step 608, the area or object associated the identifiable marking is then imaged or scanned via an optical scanner of the handheld imaging and input device. In step 610, the imaging control unit analyzes the imaged data (e.g., color, topography, metadata), and in step 612 removes superfluous data therefrom so as to extract an image associated only with the targeted object or area. Lastly, in step 614 the processed image associated with the target object or area is transmitted to the mobile computing device for insertion into electronic media content. Alternatively, the handheld imaging device may upload the imaged data associated with the object directly to an internet server for later delivery to the mobile computing device.

Embodiments of the present invention provide a system and method for editing electronic content using a handheld device. For example, the configuration of the present examples enables agile and immediate insertion of still images and video of real world objects into electronic content running on a mobile computing device. Moreover, due to the handheld imaging and input device, the user can take pictures and video at any perspective within their arm range without having to move the larger and weighty mobile computing device. By the same measure, the miniaturized camera of the handheld device allows for one-handed scanning of documents and sceneries while holding the mobile computing device with the other hand. In addition, the handheld imaging and input device mimics the user-friendly highlighter functionality which is weft-familiar to the user. Inclusion of the optical sensor on the pen-shaped device also allows for: 1) accurate selection of a target area or object, and 2) insertion of said selected area/object into a computing system, while using the same handheld imaging device.

Furthermore, while the invention has been described with respect to exemplary embodiments, one skilled in the art will recognize that numerous modifications are possible. For example, although exemplary embodiments depict a tablet personal computer as the mobile computing unit, the invention is not limited thereto. For example, the mobile computing device may be a netbook, smartphone, cell phone, or any other electronic device configured to host electronic media content. Thus, although the invention has been described with respect to exemplary embodiments, it will be appreciated that the invention is intended to cover all modifications and equivalents within the scope of the following claims.

What is claimed is:

1. A system comprising:
a mobile computing device hosting electronic content; and
a handheld imaging device in communication with mobile computing device and having an optical sensor for capturing image data associated with an object or area;
wherein the handheld imaging device is configured to both transmit said image data to the mobile computing device and also designate a location for insertion of said image data within the electronic content hosted on the mobile computing device.

2. The system of claim 1, wherein the handheld imaging device is a pen-based stylus device.

3. The system of claim 1, wherein the handheld imaging device includes a projector module configured to project an identifiable marking onto the object or area being captured by the optical sensor.

4. The system of claim 1, wherein the handheld imaging device utilizes a short-range wireless communication protocol for transferring the data associated with captured object to the mobile computing device.

5. The system of claim 1, wherein the handheld imaging device uploads the data associated with the captured object directly to an internet server.

6. The system of claim 3, wherein the projector module of the handheld imaging device is further configured to project an infrared or visible structured light grid for determining a depth map of the area or a surrounding area associated with the object.

7. The system of claim 6, wherein an imaging control unit utilizes the depth map to extract target object data from the background data so as to allow only image data associated with object to be inserted into the electronic content hosted on the mobile computing device.

8. A method for editing electronic content on a mobile computing device, the method comprising:
establishing wireless communication between a handheld imaging device and the mobile computing device;
capturing, via an optical sensor associated with the handheld imaging device, image data associated with a target object;
transmitting the image data associated with the target object from the handheld imaging device to the mobile computing device; and
inserting the image data at a designated location of the electronic content.

9. The method of claim 8, further comprising:
projecting, via a projector module of the handheld imaging device, an identifiable marking around the target object or area.

10. The method of claim 9, wherein the step of capturing image data associated with a target object further comprises:
imaging, an area associated with the identifiable marking projected by the handheld imaging device.

11. The method of claim 10, further comprising:
determining topography information associated with the object based on the imaged data.

12. The method of claim 11, further comprising:
removing superfluous data from the imaged data associated with the target object based on the topography information.

13. The method of claim 8, further comprising:
designating, via the handheld imaging device, a location for insertion of the image data within the electronic content.

14. The method of claim 8, wherein the handheld imaging device utilizes short-range wireless communication protocol for transferring the data associated with captured object to the mobile computing device.

15. The method of claim 8, wherein the handheld imaging device is configured to upload the data associated with the captured object directly to an internet server.

16. The method of claim 9, wherein the projector module of the handheld imaging device is further configured to project an infrared or visible structured light pattern for determining a depth map of the captured object.

17. The method of claim 16, further comprising:
analyzing, via a sensor processor unit of the handheld imaging device, the depth map of the captured object in order to separate and extract the target object data from background data of the captured image.

18. An electronic content editing system comprising:
a mobile computing device hosting electronic content capable of being edited by an operating user; and
a handheld imaging device having a projector module and an optical sensor for capturing image data associated with an object, wherein the handheld imaging device is configured to communicate wirelessly with the mobile device,
wherein the projector module of the handheld imaging device is configured to project an identifiable marking for designating an area or object to be captured by the optical sensor, and
wherein the handheld imaging device is configured to transfer said image data to the mobile computing device and also designate a location of insertion of said image data into the electronic content of the mobile device by the operating user.

19. The system of claim 18, wherein the projector module of the handheld imaging device is further configured to project an infrared or visible structured light pattern for determining a depth map of the captured image.

20. The system of claim 19, wherein a sensor processing module is used to separate and extract target object data from the background data so as to allow only image data associated with object to be inserted into the electronic content.
